(19) United States
(12) Patent Application Publication
(10) Pub. No.: US 2004/0031834 A1
(43) Pub. Date: Feb. 19, 2004

(54) Bicycle pack

(76) Inventor: Jarrod Barr, Meridian, ID (US)

Correspondence Address: BLACK LOWE & GRAHAM, PLLC, 701 FIFTH AVENUE, SUITE 4800, SEATTLE, WA, 98104, US

(21) Appl. No.: 10/637,106

(22) Filed: Aug. 7, 2003

Related U.S. Application Data
(60) Provisional application No. 60/401,904, filed on Aug. 7, 2002.

(51) Int. Cl. B62J 7/06; B62J 7/00; B62J 9/00; B62J 11/00

(52) U.S. Cl. 224/420; 224/426; 224/437

(57) ABSTRACT

The present invention comprises a carrier bag for attachment to the handlebars of a bicycle, including a panel. The panel has a first axis and a second axis. The second axis is perpendicular to the first axis and intersects the first axis at an intersection point to define, a right segment of the first axis and a left segment of the first axis, and to define a forward segment of the second axis and an after segment of the second axis. A right bar strap is attached to the panel on the right segment and spaced apart from the intersection point. A left bar strap is attached to the panel on the left segment and spaced apart a suitable distance from the intersection point. A stem strap is attached to the panel on the after segment and spaced apart from the intersection point and configured to encircle a stem cylinder.

### PRIORITY CLAIM

This invention claims priority from U.S. Provisional Application No. 60/401,904, entitled “PACK FOR ATTACHMENT TO BICYCLE HANDLEBARS,” filed Aug. 7, 2002.

### FIELD OF THE INVENTION

This invention relates generally to recreation packs, and more specifically to recreation packs for use with bicycles.

### BACKGROUND OF THE INVENTION

When biking, it is desirable to carry various items such as a camera, snacks, wallet, keys, or other items. Typically, however, bicycles do not have compartments for storing such items. Thus, the recreation industry has responded to the need for bicycle compartments with an assortment of cloth fabric packs.

The currently available packs generally fall into two groups: 1) those only easily and safely accessible to the rider after stopping the bicycle (such as panniers fastenable on bicycle racks); and 2) those easily and safely accessible while the rider is underway. Bicycle packs accessible while underway are generally mounted on the bicycle on either the main triangle (the triangle defined by the top tube, the down tube, and the seat tube of the bicycle frame) or on, or in proximity to, the handlebars. One simple example of a handlebar pack is a wicker basket suspended in front of handlebars by straps of leather, metal, or fabric and secured by contact with the head tube that encompasses the steering tube of the front fork of the bicycle.

Where the pack is fastened to the handlebars, the pack must be designed and placed to assure that the pack will not interfere with the safe operation of the bicycle. A weight shifting within a pack fastened to the handlebars may impart a turning force on the handlebars, impairing the control of the bicycle. The further the weight of the pack is placed away from the steering tube, the longer the lever arm, thus the greater the imparted torque. A pack fastened in front of the handlebars places the pack weight further on a longer lever arm than a pack behind the handlebars. Introducing cinch down straps compressing the pack around the weight, and using bungee hold-downs to make the weight more secure within the pack help prevent weight shifting within the pack, but these options are not always used.

Maintaining a clear vision when using bicycle packs is also a concern. A handlebar pack secured ahead of the handlebars obscures the rider's view downward such, as for viewing handlebar-mounted instruments like computers or GPS locating devices. This type of viewer's obstruction has increasingly become more of a concern as the placement of instruments on handlebars has risen with the emergence of low-cost and compact electronics. Additionally, experienced riders frequently check the status of the front wheel for trueness and the tire's inflation state frequently in the course of a ride. A poorly placed pack can obscure the rider's view of the wheel and tire when a bicycle is in use.

Thus, there currently exists an unmet need for a handlebar pack that can be secured to a location behind the handlebars, such as needed for use with a bicycle.

### SUMMARY OF THE INVENTION

The present invention comprises a carrier bag for attachment to the handlebars of a bicycle, including a panel. The panel has a first axis and a second axis. The second axis is perpendicular to the first axis and intersects the first axis at an intersection point to define, a right segment of the first axis and a left segment of the first axis, and to define a forward segment of the second axis and an after segment of the second axis. A right bar strap is attached to the panel on the right segment and spaced apart a suitable distance from the intersection point. A left bar strap is attached to the panel on the left segment and spaced apart from the intersection point. A stem strap is attached to the panel on the after segment and spaced apart from the intersection point and configured to encircle a stem cylinder.

In accordance with another preferred aspect of the present invention, the carrier bag is a collapsible bag including a containing panel adapted to collapse toward the suspension panel. The carrier bag includes a bight of a compression cord configured to urge the containing panel to collapse. In accordance with further aspects of the invention, the compression cord includes a cinch clip configured to alternately secure and release a bight of the compression cord. This configuration allows the securing of a partial load that doesn't fill the bag.

In accordance with still further preferred aspects of the invention, a first down tube strap is attached in proximity to the stem strap. The stem strap configured to attachably grasp a down tube cylinder parallel to and spaced apart from the suspension panel wherein the left and right bar straps are further configured to attachably grasp the top tube.

In accordance with yet other preferred aspects of the invention, the side panel has a third axis, substantially parallel to the first axis. The third axis bisects a plane into a third axis right segment and a third axis left segment at a third axis intersection point. The plane contains the first axis and is perpendicular to the second axis. A second right bar strap is attached to the side panel on the third axis right segment and spaced apart from the third axis intersection point. The right bar strap is configured to attachably grasp the bar cylinder of the known bar diameter, the bar cylinder being substantially parallel to the first axis. A second left bar strap is attached to the side panel on the third axis left segment and spaced apart from the third axis intersection point. The left bar strap is configured to attachably grasp the bar cylinder of the known bar diameter, the bar cylinder being substantially parallel to the first axis.

In accordance with still another preferred aspect of the preferred present invention, to attachably grasp includes encircling an object with a strap, the strap including: a first strap end, a second strap end, and an engaging mechanism configured to attach the first strap end to the second strap end strap end to encircle the object.

As will be readily appreciated from the foregoing summary, the preferred form of the present invention provides a collapsible carrier bag wherein the engaging mechanism includes: a fabric loop affixed to the first strap end; and a fabric hook affixed to the second strap end, configured to engage the fabric loop.

### BRIEF DESCRIPTION OF THE DRAWINGS

The preferred and alternative embodiments of the present invention are described in detail below with reference to the following drawings.

FIG. 1 is an isometric view of a mountain bike handlebar bag;

FIG. 2 is a top view of the mountain bike handlebar bag;

FIG. 3 is a top view of the mountain bike handlebar bag mounted on a handlebar;

FIG. 4 is an isometric view of the straps affixing the mountain bike handlebar bag to the handlebar;

FIG. 5 is a top view of the road bike handlebar bag mounted on a bike handlebar;

FIG. 6 is an isometric view of the straps affixing the road bike handlebar bag to the road bike handlebar;

FIG. 7 is a rear view of the straps affixing the road bike handlebar bag to a main triangle of a road bike;

FIG. 8 is an isometric detail view of the straps of the road bike handlebar bag embodiment; and

FIG. 9 is a frontal view of the road bike handlebar bag affixed to a main triangle of a road bike.

### DETAILED DESCRIPTION OF THE PREFERRED EMBODIMENT

By way of overview, the preferred embodiment of the present invention comprises a carrier bag for attachment to the handlebars of a bicycle and includes a carrier bag having a panel. The panel has a first axis and a second axis. The second axis is perpendicular to the first axis and intersects the first axis at an intersection point to define a right segment of the first axis and a left segment of the first axis, and to define a forward segment of the first axis and an after segment of the first axis. A right bar strap is attached to the panel on the right segment and spaced apart from the intersection point. A left bar strap is attached to the panel on the left segment and spaced apart from the intersection point. A stem strap is attached to the panel on the after segment, spaced apart from the intersection point, and configured to encircle a stem cylinder.

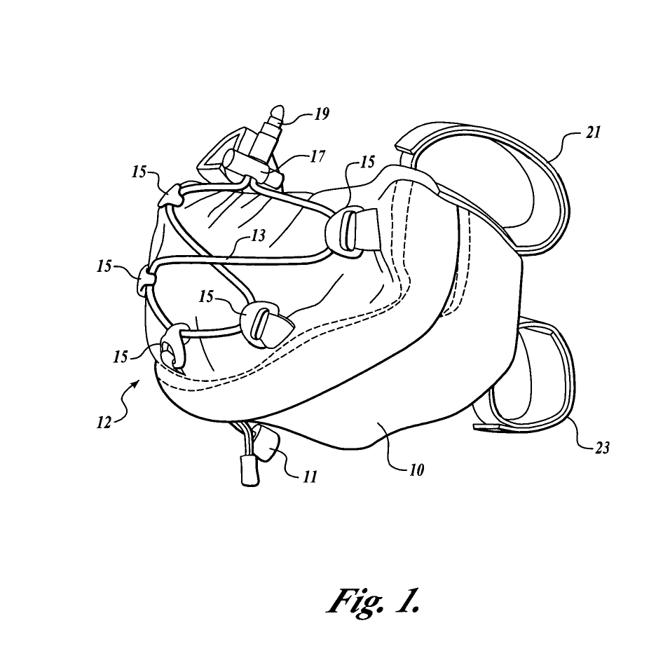

FIG. 1 is an isometric view of a mountain bike handlebar bag 10. The preferred mountain bike handlebar bag 10 embodiment comprises a bag 10 that is a triangular prism in shape, having a top triangular face 12 and an elongated lateral face. The bag 10 generally comprises six sides, including the triangular top face 12 and a bottom triangular face, as well as rectangular front, back, left, and right faces, although the faces may also be a single rectangular swatch of material joined at the ends to form a band.

The top triangular face 12 of the bag 10 is laced with a compression cord 13, the bight of which crisscrosses over the top triangular face 12 from one compression cord fixture 15 through several other compression cord fixtures 15, terminating at a compression cord cinch clip 17. The compression cord cinch clip 17 is slidingly engaged with the compression cord 13 in a manner as to allow the clip 17 to alternately lock and release the compression cord 13 to shorten or lengthen the bight. In the presently preferred embodiment, this cinch clip 17 is a spring-loaded cylinder 17 released by applying pressure at opposite ends. Alternate mechanisms may serve as a cinch clip 17, such as a cam lock. A compression cord pull clip 19 is attached to join ends of the compression cord 13 to facilitate manually drawing the compression cord 13 ends through the cinch clip 17 to shorten or lengthen the bight.

As shown in FIG. 1, the compression cord 13, compression cord fixtures 15, cinch clip 17, and compression cord pull clip 19 are arranged to contract the top triangular face 12 of the bag 10 when the bight of the compression cord 13 is shortened by drawing the compression cord 13 through the cinch clip 17. Shortening the bight of the compression cord 13 therefore contracts the volume of the bag causing the sides of the bag to tighten around a payload, preventing weight shifts of the payload.

A zipper (not visible under the overlapping edge of material) and zipper pull 11 encircle the underside edge of the top triangular face 12 such that when the zipper is opened, the top triangular face 12 will rotate about the elongated lateral side to reveal the interior compartment of the bag 10. The exterior of the bag 10 may be constructed from ballistic nylon or other similarly durable material. Although a rugged material is preferred, any material may be used. Any number of separate swatches may be used to produce the bag 10 as a whole, either stitching swatches together at corners or folding it, as appropriate. The sides of the pack, once assembled, define an interior cavity for storing items desired while biking.

The exterior of the bag 10 in the preferred embodiment is also padded. Preferably, the padding comprises foam sandwiched between the exterior ballistic nylon and an interior layer of material that may be ballistic nylon or any other substantially flexible material. Although the padding is useful in the event the bike should fall or for any other event in which the bag 10 may receive shock, padding is not required in all embodiments of the present invention.

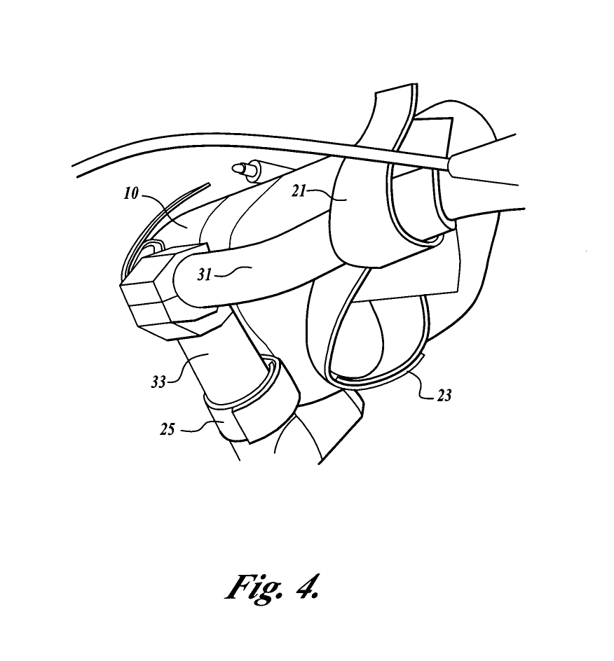

The bag 10 is fastened to the handlebars by either of two straps, the upper handlebar straps 21 or the lower handlebar straps 23. The pair of upper handlebar straps 21 are used to fasten the bag 10 to handlebars (best seen in FIG. 4) with a rise and are affixed to the elongated side of the rectangular prism the bag 10 defines. The bag 10 is attached so as to place the bag 10 behind the handlebars to rest on the stem. Such placement of the bag 10 allows clear visibility of a wheel and a front fork.

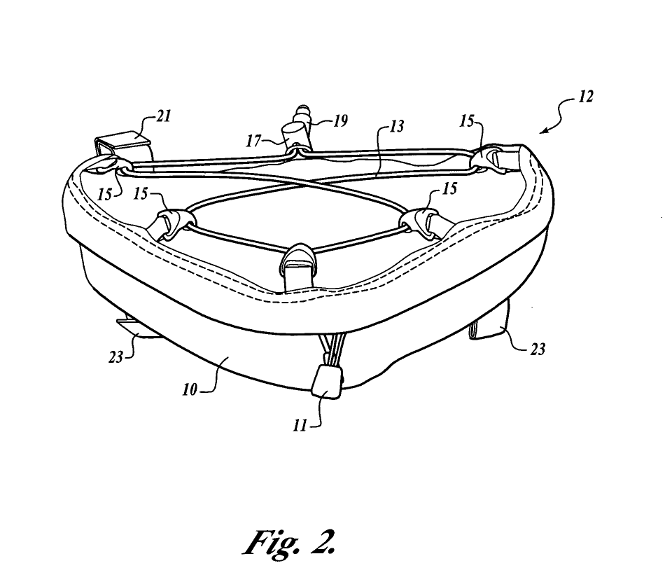

FIG. 2 is a top view of the mountain bike handlebar bag 10. The compression cord 13, compression cord fixtures 15, compression cord cinch clip 17, and compression cord pull clip 19 are on the top triangular face 12 of the bag 10. One of the pair of upper handlebar straps 21 are visible. Also visible are the pair of lower handlebar straps 23, used as an alternative to the upper handlebar straps 21. The lower handlebar straps 23 are used for handle bars with no rise or little rise such as appears on downhill bars. For owners of more than one bicycle, the bag 10 with its upper handlebar straps 21 and lower handlebar straps 23, is readily mountable and transferable from one bicycle to the other regardless of the configuration of the handlebars.

A pair of rings may be optionally attached at each end of the bag 10 on its lateral sides. The rings are configured to receive a clip at either end of a shoulder strap so that the bag 10 can be removed from the bike and easily carried by the user. As used here, the term “ring” is not meant to suggest a circular or any other particular shape, but rather to connote a connection point for a clip. Any number of alternative shapes is useful. Other fastening mechanisms are also useful, such as buckles, snaps, or quick release fasteners. When not in use, the shoulder strap is removable and can be stored inside the bag 10.

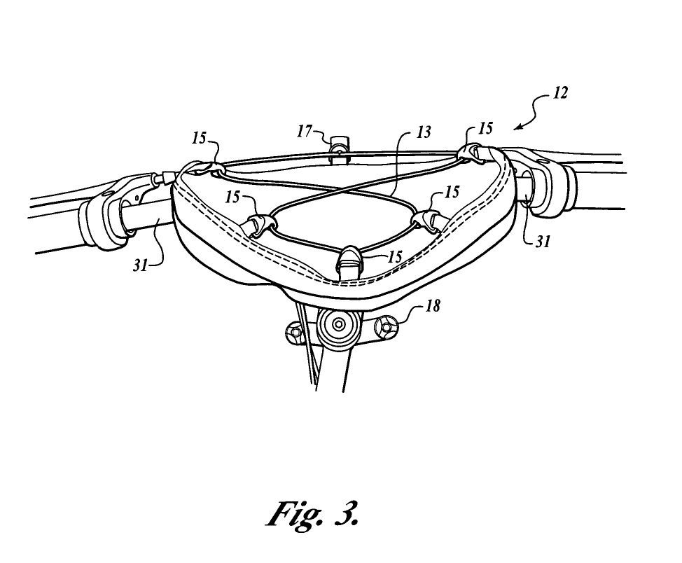

FIG. 3 is a top view of the mountain bike handlebar bag 10 embodiment mounted on a handlebar. As indicated in the discussion of FIG. 1, the upper handlebar straps 21 and lower handlebar straps 23 are placed to allow the bag 10 to sit behind the handlebars 31. Such placement allows the rider to make unobstructed and consistent visual contact to observe the wheel 16 and the fork 18. The elongated triangular prism the bag 10 defines further promotes visual contact by presenting a shortened silhouette along the direction of travel, making more of the front fork 18 visible. As arranged on the top triangular face 12 of the bag 10, when the compression cord 13, compression cord fixtures 15, compression cord cinch clip 17, and compression cord pull clip 19 are used to contract the top triangular face 12, this silhouette even further ensures visibility of the wheel 16 and fork 18.

FIG. 4 is an isometric view of the straps 21 and 23 affixing the mountain bike handlebar bag 10 embodiment to the handlebar 31. The upper handlebar straps 21 encircle the handlebar 31 due to the rise of the handlebar 31. The lower handlebar straps 23 are not used for this bar and hang free of the handlebar 31. At the vertex opposite the elongated face of the bag 10, a stem strap 25 encircles a stem 33. By fastening the bag 10 to the handlebars 31 in this fashion, the bag 10 is secure and is supported in the plane defined by the “T” of the handlebars 31 held at an intersection point by the stem 33. While exact positions of the upper handlebar straps 21, lower handlebar straps 23, and stem strap 33 may vary, the secure placement behind the handlebars 31 is achieved by securing the bag 10 to the “T” of the handlebars 31 held at an intersection point by the stem 33, thereby minimizing side to side deflection of the strap 25 by any shifting of the load within the bag 10.

Each of the straps 21 and 23 in the presently preferred mountain bike bag 10 embodiment are made from nylon or other highly durable material, and preferably includes mating a hook and loop fastener so that the straps 21 and 23 can be looped around a tube or bar and securely fastened. Other engaging mechanisms such as buckles or snaps may also be used.

At each side of the bag 10, a side pocket may optionally be provided. Each side pocket might include an upper zipper configured to provide access to the respective pocket.

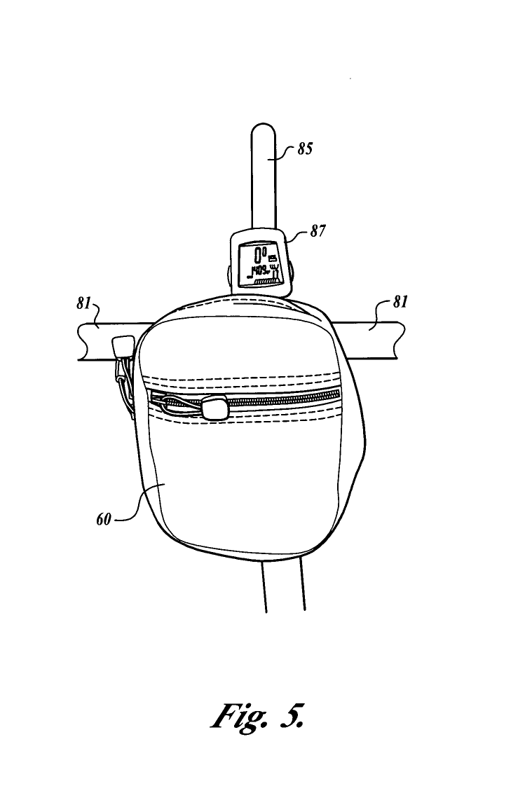

FIG. 5 is a top view of the road bike handlebar bag 60 mounted on a road handlebar 81. The bag 60 is mounted substantially behind the road bike handlebar 81 to allow visibility of the wheel 85 as mounted with the mountain bike bag 10 (FIG. 3). Additionally, the computer 87, visually communicating instantaneous speed, cadence, average speed, duration, gear development, and other information to the rider, is not obscured by the placement of the bag 60.

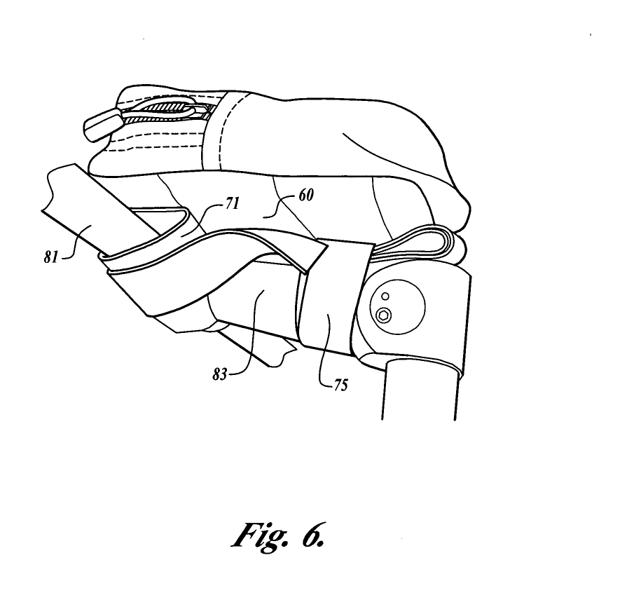

FIG. 6 is an isometric view of the straps affixing the road bike handlebar bag 60 embodiment to the road handlebar. The bag 60 is secure and is supported in the plane defined by the “T” of the handlebars 81 held at an intersection point by the stem 83. A pair of handlebar straps 71 attached to the bottom of the bag 60 encircle the handlebars 81 and a stem strap 75 also attached to the bottom of the bag 60 encircles the stem 83. The bag 60 is secure from movement in plane of the “T” as well as perpendicular to it.

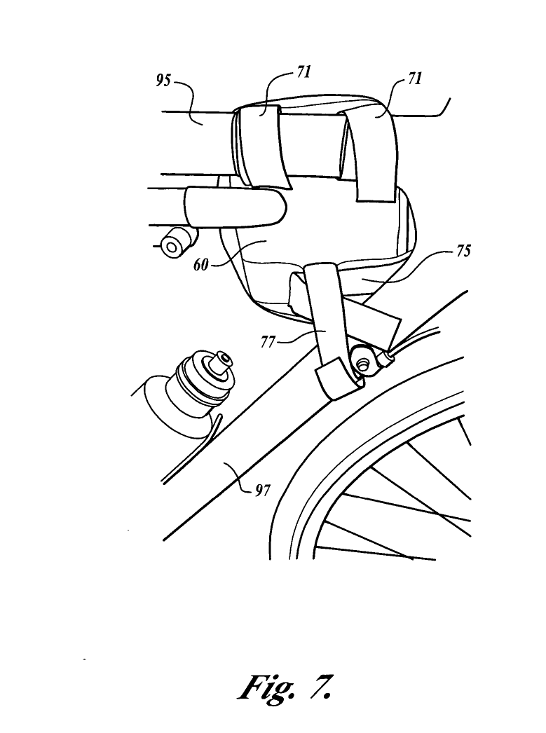

FIG. 7 is a rear view of the straps 71 and 75 affixing the road bike handlebar bag 60 to a main triangle of a road bike, i.e. a triangle formed by a top tube 95, a down tube 97 and a seat tube (not shown). An additional strap 77 is placed on the bottom of the bag 60 to advantageously allow mounting of the bag 60 on the main triangle of the bike frame. The handlebar straps 71 encircle the top tube 95 of the bicycle frame. The additional strap 77 encircles the down tube 97 to hold the bag 60 securely between the tubes.

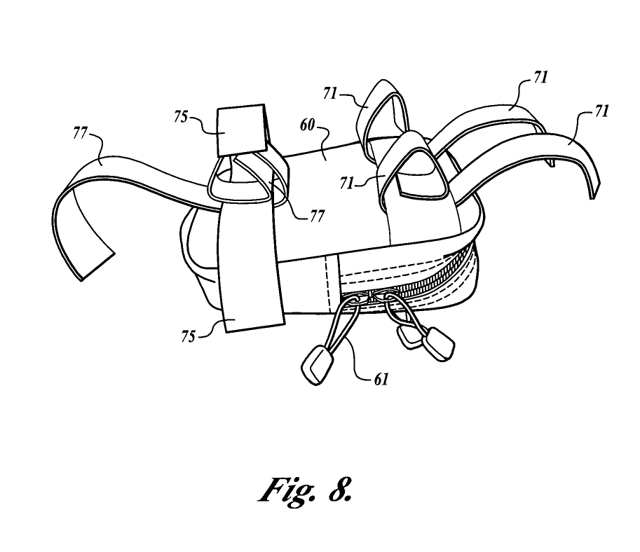

FIG. 8 is an isometric detail view of the straps 71 and 77 of the road bike handlebar bag 60. The array of straps 71 and 77 affords versatility to the bag 60. The handlebar straps 71 are shown as open pairs of straps spaced apart and affixed to the bag 60. The handlebar straps 71 are aligned on an axis parallel to an axis of the handlebars 81 (not shown) when mounted on the handlebars 81. The stem straps 75 are generally fastened at the same point and perpendicular to the down tube straps 77 to allow economy in the sewing of the straps 77, although they need not be attached at the same point. The stem straps 75 are aligned perpendicularly to the handlebar straps 71 to conform to the geometry of the handlebar stem assembly. Similarly, the down tube straps 77 are aligned generally parallel to the handlebar straps 71 and offset, although the down tube straps 77 might be canted to one side or the other to accommodate the angle of the down tube 97 (FIG. 7) with respect to the top tube 95 (FIG. 7).

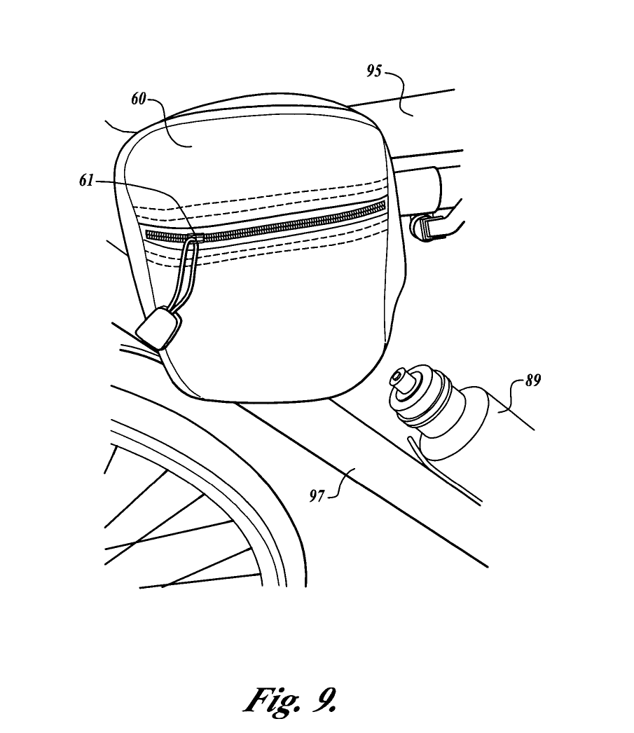

FIG. 9 is a frontal view of the road bike handlebar bag 60 affixed to a main triangle of a road bike. The zipper assembly 61 is evident. The zipper assembly 61 allows access to the interior cavity of the bag 60. A plurality of zipper assemblies 61 may be advantageously used to allow access to several pockets defined within the bag 60.

The bag 60 is held in tension between the top tube 95 and the down tube 97. The attitude of the bag 60, upright and parallel to the lateral aspects of the frame, places the bag 60 within easy reach of the rider. It is notable that in the position shown, the rider still has access to other features of the main triangle such as adjuster barrels for the shift cables or a water bottle 89.

While the preferred embodiment of the invention has been illustrated and described, as noted above, many changes can be made without departing from the spirit and scope of the invention. For example, additional compartments such as a map flap over the top of the bag 10 with a hook and loop fastener securing the flap within the view of the rider, would not depart from the spirit of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A carrier bag for attachment to the handlebars of a bicycle, the carrier bag comprising:
a suspension panel, the suspension panel having a first axis and a second axis, the second axis being substantially perpendicular to the first axis and intersecting the first axis at an intersection point to define a right segment of the first axis and a left segment of the first axis, and to define a forward segment of the second axis and an after segment of the second axis;
a right bar strap, the right bar strap being attached to the suspension panel on the right segment, the right bar strap being configured for attachment to a bar cylinder;
a left bar strap, the left bar strap being attached to the suspension panel on the left segment, the left bar strap being configured for attachment to the bar cylinder; and
a stem strap, the stem strap being attached to the suspension panel on the after segment and configured for attachment to a stem cylinder.

2. The bag of claim 1, wherein the bag is a collapsible carrier bag including a containing panel adapted to be collapsed toward the suspension panel.

3. The bag of claim 2, wherein the carrier bag further includes a compression cord configured to urge the containing panel to collapse toward the suspension panel.

4. The bag of claim 3, wherein the compression cord further includes a cinch clip, the cinch clip being configured to alternately secure and release a bight of the compression cord.

5. The bag of claim 1, further comprising a down tube strap attached in proximity to the stem strap and configured to attachably grasp a down tube cylinder parallel to the suspension panel and spaced apart from the suspension panel and wherein the left bar strap and the right bar strap are further configured to attachably grasp the top tube.

6. The bag of claim 1, further comprising:
a side panel, the side panel having a third axis, substantially parallel to the first axis, the third axis being bisected by a plane into a third axis right segment and a third axis left segment at a third axis intersection point, the plane containing the first axis and perpendicular to the second axis;
a second right bar strap, the second right bar strap being attached to the side panel on the third axis right segment, the right bar strap being configured for attachment to the bar cylinder; and
a second left bar strap, the second left bar strap being attached to the side panel on the third axis left segment and spaced apart from the third axis intersection point, the left bar strap being configured for attachment to the bar cylinder.

7. The bag according to claim 1, wherein the right bar strap, left bar strap, and stem strap each comprise:
a first strap end;
a second strap end; and
an engaging mechanism, the engaging mechanism configured to detachably engage the first strap end to the second strap end strap end.

8. The bag according to claim 7, wherein the engaging mechanism includes:
a plurality of loops affixed to the first strap end; and
a plurality of hooks affixed to the second strap end, the hooks configured to engage the loops.

9. The bag according to claim 7, wherein the engaging mechanism is selected from a group consisting of snaps, buckles, eyelets, laces, hooks and eyes, and clasps.

10. The bag according to claim 7, wherein the engaging mechanism comprises a resilient clip.

11. A bicycle having the bag according to claim 1 detachably fastened to the handlebars and stem.

12. A carrier bag for attachment to the handlebars of a bicycle, the carrier bag comprising:
a suspension panel, the suspension panel having a first axis and a second axis, the second axis perpendicular to the first axis and intersecting the first axis at an intersection point to define a forward segment of the second axis and an after segment of the second axis;
a side panel, the side panel having a third axis, substantially parallel to the first axis, the third axis being bisected by a plane into a third axis right segment and a third axis left segment at a third axis intersection point, the plane containing the first axis and perpendicular to the second axis;
a right bar strap, the right bar strap being attached to the side panel on the third axis right segment and spaced apart from the third axis intersection point, the right bar strap being configured to attachably grasp a bar cylinder, the bar cylinder being substantially parallel to the first axis;
a left bar strap, the second left bar strap being attached to the side panel on the third axis left segment and spaced apart from the third axis intersection point,
the left bar strap being configured to attachably grasp the bar cylinder, the bar cylinder being substantially parallel to the first axis; and
a stem strap, the stem strap being attached to the suspension panel on the after segment and spaced apart from the intersection point and configured to attachably grasp a stem cylinder, the stem cylinder being substantially parallel to the second axis.

13. The bag according to claim 12, wherein the bag is a collapsible carrier bag including a containing panel adapted to be collapsed toward the suspension panel.

14. The bag according to claim 13, wherein the carrier bag further includes a compression cord configured to urge the containing panel to collapse the containing panel toward the suspension panel.

15. The bag according to claim 14, wherein the compression cord further includes a cinch clip, the cinch clip being configured to alternately secure and release a bight of the compression cord.

16. The bag of claim 13, further comprising a down tube strap attached in proximity to the stem strap and configured to attachably grasp a down tube cylinder parallel to the suspension panel and spaced apart from the suspension panel and wherein the left bar strap and the right bar strap are further configured to attachably grasp the top tube.

17. A method for securing a load adjacent a junction formed by handlebars of a bicycle and a stem of the bicycle, the method comprising:
placing the load adjacent the junction, the junction including an intersection point, the intersection point being where the stem encircles and bisects the handlebar to define a right segment and a left segment, the right segment, the left segment, and the stem defining a substantially planar surface;
attachably affixing the load to the right segment at a right bar strap point, the right bar strap point spaced apart from the intersection point;
attachably affixing the load to the left segment at a left bar strap point, the left bar strap point spaced apart from the intersection point; and
attachably affixing the load to the stem at a stem strap point, the stem strap point spaced apart from the intersection point.

18. The method of claim 17, wherein:
placing the load at the intersection further includes enveloping the load in a bag, the bag having a suspension panel;
attachably affixing the load to the right segment further includes attachably grasping the right segment with a right bar strap, the right bar strap affixed to the suspension panel at the right bar strap point;
attachably affixing the load to the left segment further includes attachably grasping the left segment at the left bar strap point with a left bar strap, the left bar strap affixed to the suspension panel at the left bar strap point; and
attachably affixing the load to the stem segment further includes attachably grasping the stem segment at the stem strap point with a stem strap, the stem strap affixed to the suspension panel at the stem strap point.

19. The method of claim 18, wherein to attachably grasp includes to encircle an object with a strap, the strap including:
a first strap end;
a second strap end, and
an engaging mechanism, the engaging mechanism configured to detachably engage the first strap end to the second strap end to encircle the object.

20. The method of claim 19, wherein the engaging mechanism includes:
a fabric loop affixed to the first strap end; and
a fabric hook affixed to the second strap end, the fabric hook configured to engage the fabric loop.

21. The method of claim 19, wherein the engaging mechanism is selected from the group consisting of snaps, buckles, eyelets, laces, hooks and eyes, and clasps.

22. The method of claim 19, wherein to attachably grasp includes encircling the object with a resilient clip.

23. The method of claim 18, wherein the bag is a collapsible carrier bag including a containing panel adapted to be collapsed toward the suspension panel.

24. The method of claim 18, wherein the carrier bag further includes a bight of a compression cord configured to urge the containing panel to collapse the containing panel toward the suspension panel.

25. The method of claim 18, wherein the compression cord further includes a cinch clip, the cinch clip being configured to alternately secure and release a bight of the compression cord.
